(19) United States
(12) Patent Application Publication
(10) Pub. No.: US 2014/0032273 A1
(43) Pub. Date: Jan. 30, 2014

(54) SYSTEM OF CREDITS FOR USE WITH A NETWORK-BASED APPLICATION

(71) Applicants: Adam D'Angelo, Palo Alto, CA (US); Sandra Liu Huang, Menlo Park, CA (US); Joel Lewenstein, San Francisco, CA (US); Yair Livne, Palo Alto, CA (US); Benjamin Golub, Cambridge, MA (US); Gregory N. Price, San Francisco, CA (US)

(72) Inventors: Adam D'Angelo, Palo Alto, CA (US); Sandra Liu Huang, Menlo Park, CA (US); Joel Lewenstein, San Francisco, CA (US); Yair Livne, Palo Alto, CA (US); Benjamin Golub, Cambridge, MA (US); Gregory N. Price, San Francisco, CA (US)

(73) Assignee: Quora, Inc., Palo Alto, CA (US)

(21) Appl. No.: 13/559,482

(22) Filed: Jul. 26, 2012

(51) Int. Cl. G06Q 30/02

(52) U.S. Cl. 705/7.35

(57) ABSTRACT

A credit mechanism or system for use with a network-based application is described. The credit mechanism operates in conjunction with the network-based application to require that users pay a number of credits to interact with other users. The number of credits required to interact with a particular user may be determined using an algorithm that takes as input a number of signals that are inferred from observed data and which generally represent a measure of the particular user's willingness to provide time and attention (e.g., supply of attention), and a measure of the desire of other users to obtain the particular user's attention (e.g., demand for attention).

### TECHNICAL FIELD

The present disclosure generally relates to data processing techniques for implementing a system of credits or points—a type of virtual currency—for use with any number and variety of network-based applications or services that provide a social media platform to facilitate interaction and the exchange of information between users. More specifically, the present invention relates to a system of credits intended to model a supply-and demand market for users' attention, and to influence users' behavior in connection with a network-based application or service.

### BACKGROUND

Many network-based applications and services that are currently in use, or in development, have a social aspect. For example, users of these applications are encouraged to establish connections with other users, follow other users, or subscribe to other users and groups, for the purpose of forming virtual communities or forums via which the users can interact and exchange information. Many of these network-based applications and services rely partially, and in some cases almost entirely, on user-generated content—that is, content generated by the end-users of the particular application or service. The value of such applications and services to the users, and thus the success of any entity providing such applications and services, is heavily dependent upon the ability to attract and retain users who are willing to participate, for example, by interacting with other users and generating desirable, quality content that is to be shared with other users.

One common problem that frequently occurs with this type of network-based application or service is that certain users may become overwhelmed by being the recipient or subject of an extremely high volume of messages, requests or other types of user interactions. For example, in the context of a social network service, certain high-profile users such as celebrities (e.g., actors, athletes, politicians, etc.) may receive an extremely high number of messages and/or requests, or be the subject of other types of user interactions. In the context of a business or professional network service (e.g., a social network service for professionals and career-oriented persons), certain users whose profiles indicate they hold certain job titles (e.g., recruiter, CEO, board member, etc.) may receive a similarly large number of messages and/or requests. In the context of a question-and-answer application or service, via which users can direct questions to, and receive answers from, other users, certain users' attention may be highly sought after due to those users having previously provided valuable information in an answer to a question, having a certain job title, and/or being known to have expertise in a particular subject matter.

There are generally several undesirable effects of not having any mechanisms in place to control or manage the rate or level at which users seek the attention of other users (particularly certain high profile or prominent users), for example, by directing messages, requests, and/or questions to those users. First, because certain users are flooded with too many messages, requests, questions, and so forth, it becomes difficult if not impossible for these users to identify the important user interactions from the less important. Accordingly, a prominent or high-profile user who is overwhelmed by an extremely large volume of messages, requests, questions, or other users' interactions, may simply choose not to participate in the particular forum or virtual community. Consequently, if users who have expertise in certain subject areas are not responding or are responding at a low rate to messages, requests, or questions, then the users who are interested in these particular subject areas are less likely to spend the time interacting with the experts. The result is that the usefulness and value of the network-based application or service is diminished for all of its users.

### DESCRIPTION OF THE DRAWINGS

Some embodiments of the invention are illustrated by way of example, and not limitation, in the figures of the accompanying drawings, in which:

FIG. 1 is a system-level block diagram illustrating some of the system components and functional modules used in implementing a question-and-answer service having a credit system consistent with some embodiments of the invention;

FIG. 2 is a flow diagram illustrating the method operations performed by a credit management module for establishing the price, payable in credits, to interact with a user of a web-based application, for example, by directing messages, requests, questions, etc., to the user, according to some embodiments of the invention;

FIG. 3 is a use case diagram illustrating an example of some of the ways in which users can spend and earn credits in the context of a question-and-answer service, consistent with some embodiments of the invention;

FIG. 4 is a user interface diagram illustrating an example of a user interface or web-page of a question-and-answer service and showing how a user can select another user to whom a question is to be directed, according to some embodiments of the invention;

FIG. 5 is a user interface diagram illustrating an example of a user interface or web-page of a question-and-answer service and showing a list of questions that have been directed to a particular user, consistent with some embodiments of the invention;

FIG. 6 is a user interface diagram illustrating an example of a user interface or web-page of a question-and-answer service and showing a list of activities for which credits were earned and paid out, consistent with some embodiments of the invention;

FIG. 7 is a user interface diagram illustrating an example of a user interface or web-page of a question-and-answer service and showing a leaderboard listing the users who have the most credits earned for a particular topic, consistent with some embodiments of the invention; and

FIG. 8 is a block diagram of a machine in the form of a computer within which a set of instructions, for causing the machine to perform any one or more of the methodologies discussed herein, may be stored and executed.

### DETAILED DESCRIPTION

Methods and systems for implementing a system of credits for use with a network-based application or service are described. In the following description, for purposes of explanation, numerous specific details are set forth in order to provide a thorough understanding of the various aspects of different embodiments of the present invention. It will be evident, however, to one skilled in the art, that the present invention may be practiced without these specific details.

Consistent with various embodiments of the invention, a network-based application or service includes a credit mechanism or system for allocating credits or points to end-users, and then requiring that the credits be used as payment in exchange for performing various actions that involve an interaction or exchange of information with one or more other users of the application or service. For example, in the context of a social network service, a user may be required to pay a certain number of credits to publish a status update message or share some web-based content via a data feed, also commonly referred to as a news feed or status update stream. In the context of a business or professional network service, a user may be required to pay a certain number of credits in exchange for directing a message or request to another user of the professional network service. In the context of a question-and-answer service, a user may be required to pay a certain number of credits to post a new question to be viewed by the users of the service, or to solicit an answer to a new or previously posted question from a particular user of the service. Generally, a credit mechanism or system as described herein can be advantageously implemented with any number and variety of network-based applications where it is important to limit or otherwise regulate the volume of messages or requests made to access a scarce resource, such as the attention of a user of a network-based application.

Consistent with some embodiments, users are initially allocated a certain number of credits that can be used to interact with other users. The particular type of interactions that are subject to the payment of credits are those interactions that will necessarily be seeking the time or attention of other users, and will generally be dependent upon the specific nature of the application or service. For instance, with a social network service or a professional network service, the interaction may involve, sharing a status update, messaging a user, making some specific type of request (e.g., a referral or endorsement request) of the user, and so forth. In the context of a question-and-answer service, the interaction may involve posting a new question to all users of the service, or soliciting an answer to a particular question from another user, for instance, by directing a new or previously posted question to the user. In addition to receiving an initial allocation of credits, users can earn credits in various ways by giving their time and attention, for example, by responding to messages or requests, answering questions, or making various other positive contributions to the forum or virtual community. Furthermore, at least with some embodiments, each user will have his or her credits periodically refreshed, for example, by receiving an additional allocation of credits to ensure that the user can continue to participate in the particular forum or virtual community. With some embodiments, the credits or points will have no direct association with a real (i.e., government issued) currency. However, with some alternative embodiments, credits or points may be purchased with, and/or redeemed for, a real currency.

Consistent with some embodiments, the number of credits required to interact with a user or group of users may be dependent upon the type or nature of the interaction (e.g., message, request, question, etc.), the category or subject matter to which the content of the interaction relates, and/or the specific user or group of users to whom the interaction is being directed. For instance, the number of credits required to send a message (e.g., such as an email) to a user may differ from the number of credits required to perform some other action, such as directing a specific question to the user, or sharing or publishing some content to a data feed accessible to the user. Additionally, the number of credits required to direct a particular message, request or question to one user may be different from the number of credits required to direct the same message, request or question to another user. The number of credits required to ask a user or group of users a question relating to one topic or subject matter (e.g., a question concerning a legal issue) may differ from the number of credits required to ask the same user or group a question relating to a different topic or subject matter (e.g., a question concerning a celebrity marriage).

With some embodiments, the credit mechanism or system provides what might be referred to as individual demand-based pricing for messaging other users. For example, the credit mechanism or system initially defines a default price to be paid to interact in a particular way with each user. The credit mechanism or system will then monitor the rate of interactions directed to each user, as well as the rate at which each user responds to interactions. The credit mechanism or system will then adjust the price for interacting with each user with a view to achieving some system-defined goal or objective. For instance, the credit mechanism or system may simply adjust the price to interact with a particular user to reflect the overall demand for that user's attention, where the measure of demand is derived based on various factors, for example, to include the historical rate of interactions being directed to the user by other users over a given period of time, the total number of interactions or requests generated by all users over a given period of time, the rate at which the user responds to requests generally as well as requests relating to specific topics or subject matters, and/or the overall number of user interactions relating to a specific topic or subject matter. For instance, the credit mechanism or system may increase the price to interact in some way with a particular user when the rate of interactions (e.g., messages, requests, questions, etc.) being directed to the particular user exceeds some target or threshold rate, or when the total number of user interactions occurring in a given time period exceeds some target or threshold rate. Similarly, the price to interact in some way with a particular user may be lowered when the rate of interactions (e.g., messages, requests, questions, etc.) being directed at the particular user falls short of some target or threshold rate, or the total number of user interactions falls short of some target or threshold number. Accordingly, at least with some embodiments, the price setting mechanism of the credit system attempts to ensure that each user receives a number of requests or interactions that is appropriate in view of various user-specific factors and system-defined goals or objectives. With some embodiments, a user can override the default settings of the price setting mechanism by raising or lowering the price to be paid to interact with the user, or by adjusting the desired threshold or target rate of interactions. For example, by increasing the price, the user is effectively signaling that he or she would like fewer interactions, while decreasing the price is effectively signaling that he or she would like more interactions. Similarly, increasing the target rate of interactions would cause the price to be decreased, while decreasing the target rate of interactions would cause the price to be increased.

By implementing a credit mechanism or system as described herein, a supply-and-demand market for a scarce resource (e.g., the attention of users) is established, thereby influencing how users of an application or service interact with the application or service generally, and other users in particular. For instance, if one views the attention of a user of an application or service as a scarce resource—for example, a resource that is short in supply—implementing a credit system via which users are required to pay credits when the users want access to the resource (e.g., by messaging, or directing a request or question to a user) will have the effect of decreasing the demand for the resource. Stated more simply, if a user has to pay credits or points in exchange for interacting with another user, the user is more likely to think twice about whether the value of the interaction equals the perceived value of the credits. Consequently, a credit system as described herein provides a sort of self-regulating quality assurance mechanism by compelling users to consider the value of spending or paying credits in exchange for taking some action that will necessarily require the attention of one or more other users of the application or service. Furthermore, with a system of credits, the prices select for the people who are interested the most, and have the available credits to spend, in the expertise and knowledge of other users. Additionally, because users are provided with credits or points in exchange for performing certain desired actions, the system of credits can be used to reward certain desirable behaviors, thereby influencing users to behave in a manner that is generally beneficial to the forum or virtual community. Ultimately, with a system of credits in place, the lower quality and/or less meaningful interactions and content contributions will diminish, thereby improving the overall quality of interactions and content contributions. The dynamic nature of the pricing and economic-based system described herein allows for a strong representation of the supply of and demand for user's attention as it relates to a web-based application or service that solicits user-generated content. As a result, the system maximizes value for contributors and solicitors and maximizes the amount of useful content that exists on the site. Other advantages of the inventive subject matter described herein will be readily apparent from the description of the figures that follows.

Many of the examples and illustrations provided herein describe or present the inventive subject matter in the particular context of a network- or web-based, question-and-answer application or service. However, skilled artisans will immediately recognize a host of other contexts, including other network-based applications and services, to which the inventive concepts are applicable. In particular, the inventive concepts described herein will find application in a wide-variety of network- or web-based services that rely on user-generated content and/or implement or leverage a social media platform enabling users to interact and exchange information. Some of the specific types of network-based applications or services to which the inventive concepts are applicable include, but are not limited to, social network services including business and professional network services, wiki-based dictionary or encyclopedia services, music and video services, and many others.

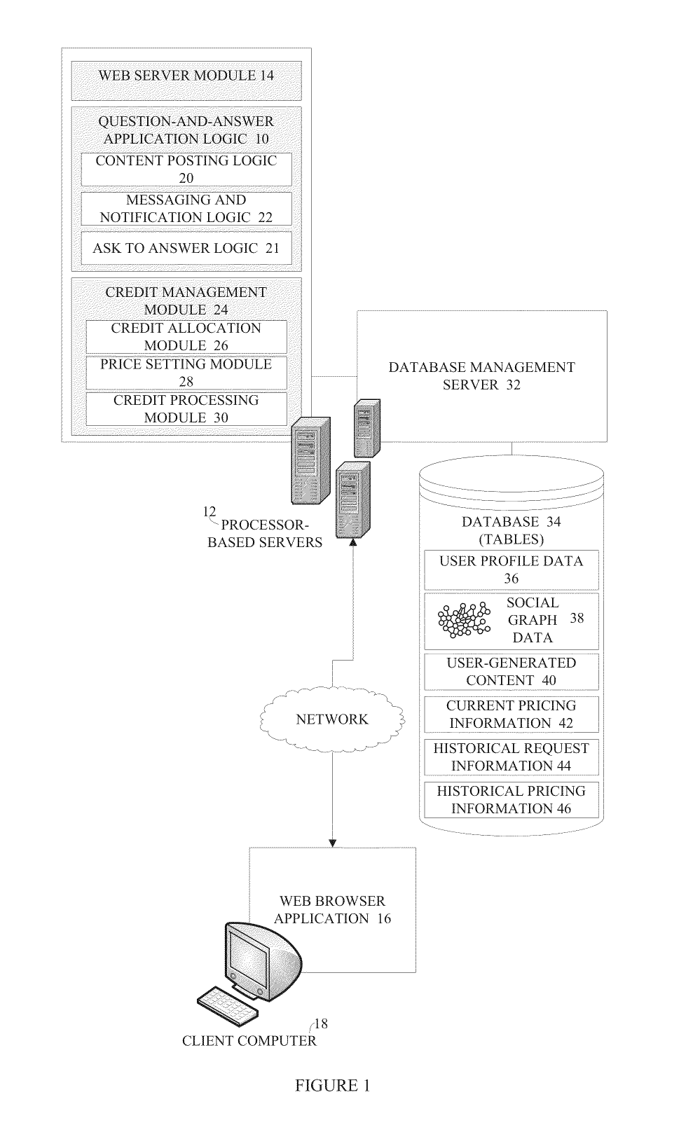

FIG. 1 is a system-level block diagram illustrating some of the system components and functional modules used in implementing a question-and-answer service having a credit mechanism or system consistent with an embodiment of the invention. As illustrated in FIG. 1, with some embodiments, a question-and-answer service is implemented as a web-based application having application logic 10 residing at one or more processor-based computer servers 12. At least some of the servers 12 include a web server component or module 14 for serving data (e.g., documents or web pages) to a conventional web browser application 16 residing and executing at a client computer 18. In addition, or as an alternative, the web server module 14 may utilize one or more web-based protocols to serve content to non-web browser clients, such as a web-based mobile application residing and executing on a mobile computing device, a set-top box, a television, or some other computing device.

As is understood by skilled artisans in the relevant computer and Internet-related arts, each module or logic component shown in FIG. 1 represents a set of executable software instructions and the corresponding hardware (e.g., memory and processor(s)) for executing the instructions. To avoid obscuring the inventive subject matter with unnecessary detail, various functional modules and/or logic components that are not germane to conveying an understanding of the inventive subject matter have been omitted from FIG. 1. However, a skilled artisan will readily recognize that various additional functional modules and logic components may be used with a network- or web-based application, such as that illustrated in FIG. 1, to facilitate additional functionality that is not specifically described herein. Furthermore, the various functional modules and logic components depicted in FIG. 1 may reside on a single server computer, or may be distributed across several server computers in various arrangements.

As illustrated in FIG. 1, the client computer 18 executes a web browser application 16 to access the web-based question-and-answer application. In various alternative embodiments, the client computer 18 may be a mobile computing device, to include: a laptop, mobile phone, e-book reader, or tablet computer. As such, with some embodiments, the question-and-answer application may have an interface that is customized for display in a browser, or mobile application, of a mobile device. Furthermore, with some embodiments, the client-based application may not be browser-based, but instead may be customized to suit the particular operating system of the device on which it is executing. For instance, a customized application may utilize one or more application programming interfaces that are unique to the particular device and operating system on which the customized application resides and executes.

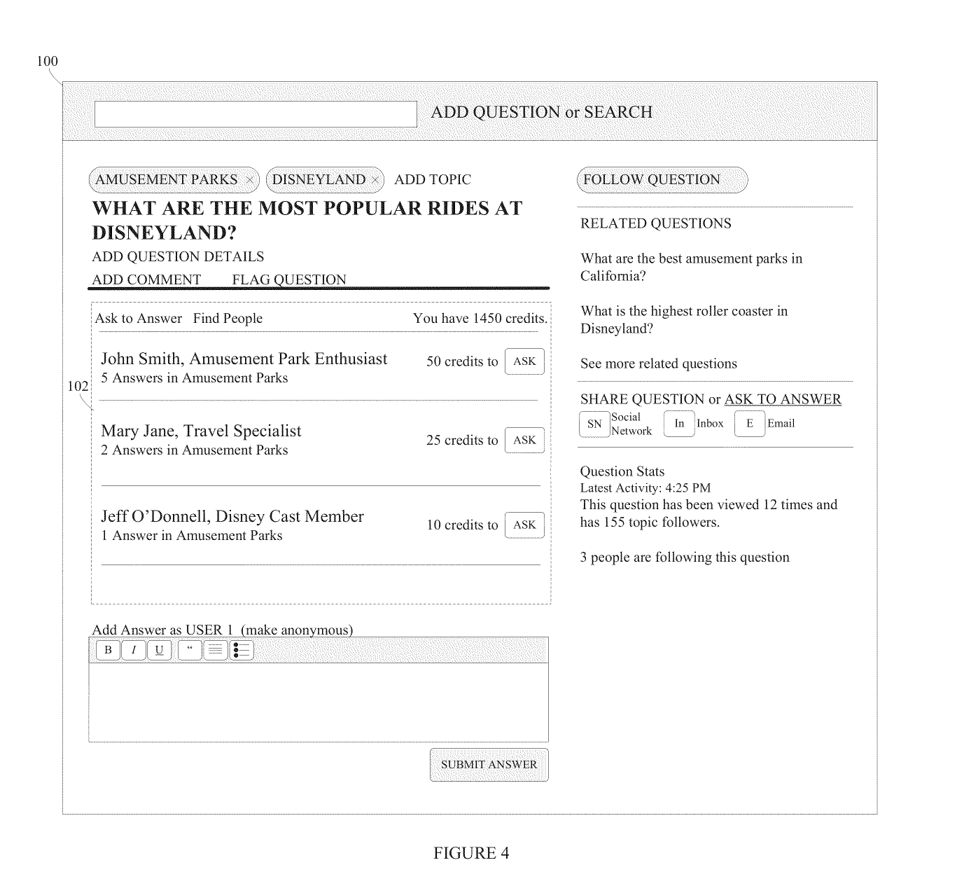

The question-and-answer application logic 10 is shown in FIG. 1 to include content posting logic 20, messaging and notification logic 22, and ask to answer logic 21. In general, the content posting logic 20 enables users to post questions, answers and comments, as well as other content-related items of information. The messaging and notification logic 22 operates in conjunction with the content posting logic 20 to facilitate the generation and communication of messages and notifications. Accordingly, when a first user posts an answer to a second user's question via the content posting logic 20, the messaging and notification logic 22 will message or notify the second user of the newly provided answer. The ask to answer logic 21 analyzes a variety of information to suggest to a user the names of other users who, for various reasons, may be persons to whom a question should be directed. For example, the suggested users may be selected because they are likely to answer a particular question, because they are likely to know the answer to the question, or for some other reason, as described more completely below in connection with FIG. 4. Of course, the application logic 30 may include a number of other logic components to perform a variety of other tasks and functions beyond the immediate scope of the present inventive subject matter. In particular, the inventive concepts described herein might be implemented with a question-and-answer application or service consistent with any one or more of the features and functionality described in related U.S. patent application Ser. No. 12/795,482, entitled, “Methods and Systems for Merging Topics Assigned to Content Items in an Online Community,” filed Jun. 7, 2012; U.S. patent application Ser. No. 12/983,056, entitled, “Methods and Systems for Soliciting an Answer to a Question,” filed Dec. 31, 2010; and, U.S. patent application Ser. No. 12/983,062, entitled, “A Multi-Functional Navigation Bar,” filed on Dec. 31, 2010. However, to avoid obscuring the inventive subject matter with unnecessary detail, the various functional components have not been included in FIG. 1.

As illustrated in FIG. 1, the application logic 10 operates in conjunction with a credit management module 24. Accordingly, as users interact with the question-and-answer service by posting content and taking certain actions, the credit management module 24 will process the credits associated with the various actions, for example, by debiting a user's credit account, and/or paying out credits to a user's credit account. For example, as illustrated in FIG. 1, the credit management module 24 includes a credit allocation module 26. With some embodiments, the credit allocation module 26 will allocate a certain number of initial credits to a user when the user first signs up, or registers, to be a user of the service. Similarly, with some embodiments, the credit allocation module 26 will periodically refresh the credit accounts of users who have used up all of their credits. This ensures that users will be able to continue to use the service.

The credit management module 24 also includes a price setting module 28. With some embodiments, the price setting module 28 facilitates what might be referred to as individual demand-based pricing for various user-interactions. For instance, with some embodiments, the price setting module 28 will, on a per-user basis, vary the price required to solicit an answer from a user to reflect the level of demand for that user's time and attention. The measure of demand may be based on the number of solicitations that the user has received over a period of time, as well as the prices paid by those who have solicited the user for an answer. In setting the price for a particular user, the price setting module 24 may also derive a measure of the user's willingness to provide time and attention, for example, by monitoring the rate at which the particular user has responded to solicitations for answers to questions, the rate at which the user expressly declines to answer a question (as opposed to simply ignoring the question), the rate at which the user adds other users to a blocked user list to prevent receiving further requests from those users, and/or by taking into consideration the number of solicitations desired as established by the user, or as a system default. Accordingly, if a particular user receives an extremely high volume of requests to answer questions, but has expressed a willingness to provide answers, the price setting module 28 may increase the price others have to pay to solicit an answer from that particular user, but less than if the particular user had expressed no willingness to respond to questions. In other words, the target rate of interactions for a particular user may be influenced (increased or decreased) based on their willingness to provide time and attention, as determined or derived by their level of responsiveness to the questions directed to the user. In addition to algorithmically regulating the price based on various inferred signals, the price-setting module 28 enables a user to manually adjust or change the price that others have to pay to solicit an answer from the user. Accordingly, if the user prefers to receive a greater number of requests for answers, the user may lower his or her price. If the user prefers to receive fewer requests for answers, the user can raise his or her price. With some embodiments, the user may be able to establish a desired volume of requests (e.g., three requests or solicitations per week), and the price setting module 28 will then adjust the price others have to pay to solicit an answer from the user with the objective of getting the user the desired number of requests or solicitations.

In addition, or as an alternative, to manipulating the price required to solicit an answer from a user based on the demand for the user's attention, with other embodiments the price setting module 24 may, on a per-user basis, vary the price required to solicit an answer from a user based on a variety of other factors and to achieve various system-defined goals or objectives. For example, with some embodiments, the price setting module 24 may establish a price for soliciting an answer to a question from a particular user based on any one or more combinations of the following factors: the number of solicitations that a user has received from other users over a particular period of time, the aggregate price paid by other users in soliciting answers from the particular user, the rate at which the user responds to all solicitations for answers, the rate at which the user responds to solicitations for answers relating to particular topics or subject matters, the total number of questions that have been posted, the number of questions posted to the service that relate to a certain topic or subject matter, the total number of unanswered questions, and/or the number of unanswered questions relating to a particular topic or subject matter. The particular factors that affect the price that others pay to solicit an answer from a particular user, and the particular influence those factors have on the price (e.g., increasing or decreasing the price) will generally depend on a particular desired goal or objective. In some instances, for example, the goal may be to find equilibrium between the amount of time or attention that a particular user is willing to provide, and the amount of time or attention that other users are seeking of the particular user. In other instances, the price setting module 24 may be used to influence (increase or decrease) the level of interactions (e.g., questions and answers) that are occurring in a particular topic or subject matter. In other instances, the price setting module 24 may be used to influence the rate at which questions are posted, and/or, answers are provided. In some instances, the price setting module 25 may be configured to consider various observed factors and to establish prices that will limit the posting of undesirable content, or spam. Of course, the price setting module 24 may be used to establish prices that convey a wide variety of other information, and/or to achieve a wide variety of other objectives and/or goals.

The credit management module 30 also includes a credit processing module 30. The credit processing module 30 generally receives as input information indicating the various actions that users have undertaken and, in response, will add or subtract credits from a user's credit account based on the particular price for performing the action. For example, when a user posts a question for all users of the service to view, the credit processing module 30 will debit a certain number of credits from the user's account. Similarly, when the user solicits an answer from another user, the credit processing module 30 will debit the appropriate number of credits from the user's account. In some instances, the credit processing module 30 simply processes transactions amongst users, such that the credits paid out by one user are simply transferred to another user. For example, when a first user solicits a second user for an answer, the entire price paid by the first user may be transferred to the second user. In other instances, credits that are paid may be banked or held by the system. For example, when a user pays to post a question, the paid credits may be held in an account of the credit management module. In other instances, the credit processing module is generating or creating new credits to be paid out. In yet other instances, the system may keep a percentage of any credit payment or transaction as a fee or commission.

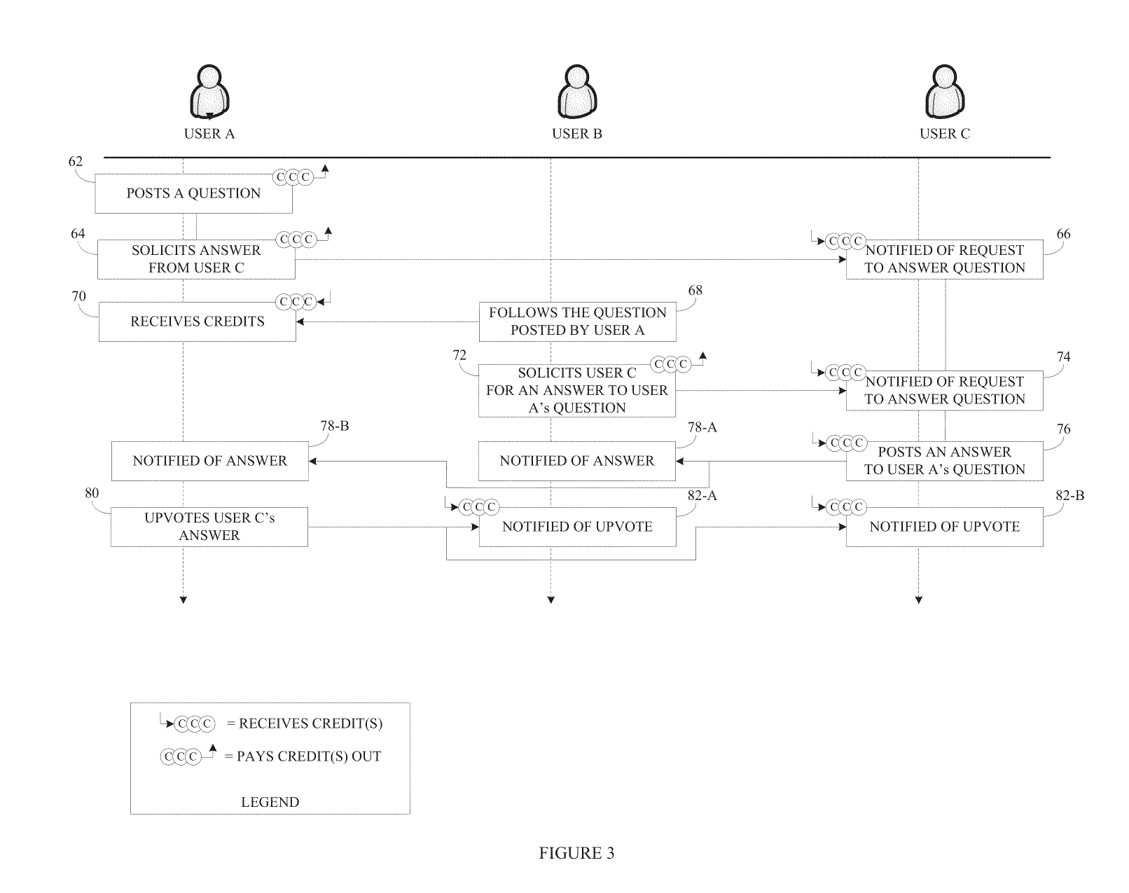

The credit processing module 30 will add credits to users' accounts when users give their time and attention by taking certain actions that positively contribute to the virtual community or forum. For instance, with some embodiments, when a first user posts a question, and a second user follows the question, the first user earns a certain number of credits. These credits are, in a sense, a reward for positively contributing to the service, for example, by posting a question that is of interest to other users. When a first user is solicited for an answer to a particular question, the first user will receive credits for answering the question. When a first user solicits a second user for an answer to a question that was posted by a third user, the first user (who solicited the second user for the answer) will receive some credits when the answer provided by the second user is voted up by another user. If the user who votes up the answer is the same user who posted the question, the number of credits paid to the user who provided the answer may be increased. When a first user answers a question, the user who initially invited the first user to join the virtual community or forum may receive credits. Some examples of the particular actions that users might perform to earn credits are described in connection with the description of FIG. 3 below.

With some embodiments, some of the various functional components of the question-and-answer application, including some of the various software modules, may be distributed across several server computers, providing application reliability and scalability. For instance, as illustrated in FIG. 1, the database management server 32 is shown to reside on a separate server computer. However, in other embodiments the database management server 32 might reside and execute at the same server as the application logic 10, web server module 14 and/or credit management module 24. In any case, the database management server 32 facilitates the writing and reading of data stored in tables of a database 34. With some alternative embodiments, other data structures may be utilized in addition to, or in place of, database tables.

As shown in FIG. 1, some of the data that is stored in database tables 34 includes user profile data 36, social graph data 38 user-generated content 40, current pricing information 42, historical request information 44, and historical pricing information 46. Generally, user profile data includes personal information about each user, such as their name, email address, telephone number, place of employment, educational background, and/or any other type of personal information that might be commonly found on a resume or curriculum vitae. The social graph data 38 includes information about the various relationships that exist between users of the service, and the content (e.g., questions, answers, comments, etc.) that each user has subscribed to, or follows. For example, with some embodiments, users can follow another user—a type of unilateral relationship—and then be informed about information posted to the service by the user that is being followed. In some instances, two users may follow one another—a bi-lateral relationship, sometimes referred to as a direct connection. With some embodiments, certain user-interactions may be priced differently when two users are following one another. For example, soliciting an answer from a user with whom a bi-lateral relationship exists (e.g., each user is following the other) may be free. The user-generated content 40 stored in the database tables includes the text of questions, answers, comments, and so forth. The current pricing information 42 includes the prices for performing certain actions, to include posting a question relating to a particular topic, asking a particular user to answer a question, and other actions. The historical request or interaction information 44 includes information indicating the different interactions that have occurred between users of the system, while the historical pricing information 46 specifies the prices at which previous interactions occurred, as well as the previous prices for performing certain actions, such as, asking another user to answer a question.

Consistent with some embodiments, the question-and-answer service is a stand-alone service accessible via its own unique address (e.g., URL or URI). With some embodiments, the stand-alone service may leverage its own social layer or social graph (e.g., such as the social graph data 38), or a social layer or social graph that is provided by an externally-hosted social network service. Accordingly, various relationships between users, as determined or defined by the question-and-answer service or an externally-hosted social network service, may be utilized to customize the functionality and features of the question-and-answer service. For example, search results displayed via a navigation bar may be ranked and ordered based, at least in part, on the relationship that the user performing the search has with other users, as that relationship is defined by the question-and-answer service, or an external social network service. Alternatively, with some embodiments, the question-and-answer service may be one of several applications or services that are associated with, and provided by, a social network service. For instance, the question-and-answer service may be accessible via the same address or domain by which users access a social network service, such that the question-and-answer service is hosted by the same entity providing the social network service.

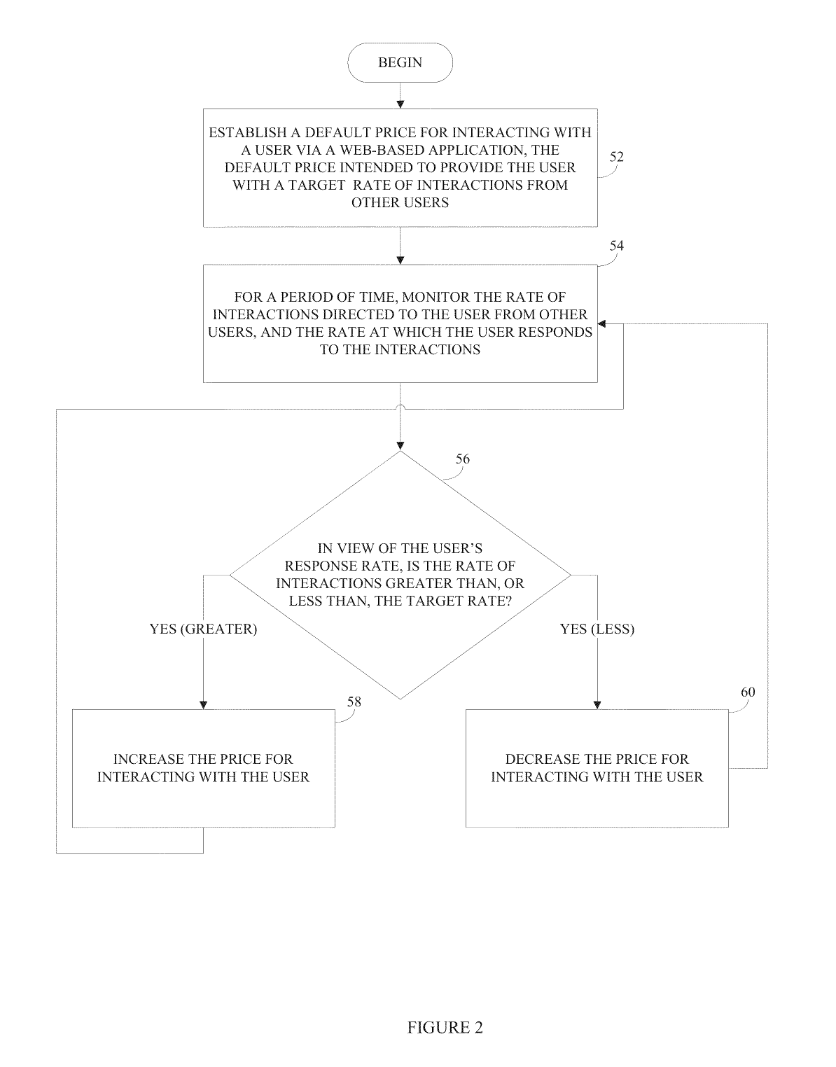

FIG. 2 is a flow diagram illustrating the method operations performed by a credit management module for establishing the price, payable in credits, to interact with a user of a web-based application, for example, by directing messages, requests, questions, etc., to the user, according to some embodiments of the invention. The method begins at method operation 52 when the price setting mechanism or module establishes an initial default price for interacting with a user in some way. For example, in the context of a question-and-answer service, the default price to solicit a particular user for an answer to a question may initially be established with the objective of getting that particular user a target rate of solicitations from other users.

Next, at method operation 54, the credit management module monitors various events and activities, such as the rate at which other users interact with the particular user, to derive a measure of demand for that particular user's time and attention. Additionally, the credit management module derives a measure of the user's willingness to interact with the application or service, for example, by monitoring the rate at which the particular user responds to the interactions directed to the user from other users. For example, in the context of a question-and-answer service, the credit management module may monitor the number of requests or solicitations to answer questions that are received by the particular user, as well as the number of responses or answers that are provided by the particular user. At method operation 56, the credit management module analyzes the rate at which the user is receiving requests or solicitations for answers, in view of the rate at which the user is responding, and compares this to some target or threshold rate. The target or threshold rate may be personalized for the particular user and may vary based on the user's willingness to provide time and attention, as determined by the user's response rate—that is, the ratio of the number of answers the user provides to the number of questions directed to the user. If, in view of the user's response rate, the rate of interactions (e.g., answers solicited from the user) is greater than the target rate for the given time period, then at method operation 58 the price for interacting with the user is increased. However, if the historical rate of interactions (e.g., answers solicited from the user) is less than the personalized target rate for the given time period, then at method operation 60 the price for interacting with the user is decreased. Of course, with some embodiments, the difference between the observed (i.e., historical) rate and the target rate will need to be sufficiently large before the price is changed, and there may be lower and upper bounds such that the price is not increased or decreased outside of the specified bounds.

FIG. 3 is a use case diagram illustrating an example of some of the ways in which users can spend and earn credits in the context of a question-and-answer service, consistent with some embodiments of the invention. In the example illustrated in FIG. 3, USER A posts a question to the question-and-answer service, as indicated by reference number 62. Posting of the question makes the question viewable to the entire community of users and costs USER A a certain number of credits (e.g., fifty credits). Upon posting the question, USER A is immediately presented with a user interface or web page that includes one or more suggested users from whom USER A might solicit an answer to the question. For example, the question-and-answer service may analyze the text of the question and the topic or topics to which the question has been assigned, and then identify one or more persons who may be well-suited to answer the question. These persons are then presented to USER A as suggestions for who USER A might solicit an answer. An example of such a user interface or web page is shown in FIG. 4. Some of the techniques for suggesting persons to answer a question are described in U.S. patent application Ser. No. 12/983,056, entitled, “Methods and Systems for Soliciting an Answer to a Question,” filed on Dec. 31, 2010.

Next, USER A solicits USER C for an answer to the question that was just posted, as indicated by reference number 64. Here again, USER A pays a certain number of credits. In this case, the number of credits is equivalent to the price for soliciting USER C for an answer to a question. That is, the number of credits that USER A pays to solicit an answer from USER C is specific to USER C, and may be referred to as USER C's “Ask to Answer” price. As indicated by reference number 66, USER C is notified of the request to answer the question posted by USER A, and also receives some credits for simply having received the request. This credit allocation to USER C is, in a sense, a payment for having been bothered with the request. The amount of credits received for simply receiving the request may be a portion of USER C's Ask to Answer price as paid by USER A. If USER C does not post an answer to the question, some portion of the credits that USER A has paid to solicit the answer from USER C will be refunded to USER A. This may occur, for example, if USER C does not answer within a particular time limit established as a system default, or as set by USER A.

After USER A posts the question, USER B views the question. For example, the question posted by USER A may be assigned to a particular topic that USER B is following, and therefore the question appears in a data feed that is personalized for USER B. Because USER B finds the question to be of interest, USER B decides to follow the question, as indicated by reference number 68. As a result of USER B following the question, USER A receives credits. For example, USER A is, in a sense, rewarded for having posted a question that is of interest to another user, as indicated by USER B following the question. Consequently, USER A is allocated a number of credits (e.g., ten credits) as indicated by reference number 70. In addition to following the question, USER B decides to solicit USER C for an answer to the question, as indicated by reference number 72. Accordingly, USER B pays an amount of credits equal to USER C's Ask to Answer price. As a result of USER B soliciting an answer from USER C, USER C is again notified of the request for an answer and receives some credits, as indicated by reference number 74.

When USER C posts an answer to the question, as indicated in FIG. 3 by reference number 76, USER C earns credits for posting the answer. In some embodiments, USER C will earn the remaining portion of his Ask to Answer price—that is, the portion of his Ask to Answer price that he did not receive as a result of being solicited for an answer. In addition, USER A and USER B will receive notifications, as indicated by reference numbers 78-A and 78-B, indicating that USER C has posted an answer to the question.

When USER A reads the answer provided by USER C, USER A may decide to vote up USER C's answer, as indicated in FIG. 3 by reference number 80. For example, if the question receives several answers, voting up the answer will cause the answer to be presented more prominently in a list of answers. When USER A votes up USER C's answer, USER C will earn credits for positively contributing to the virtual community or forum by providing the answer, as indicated by reference number 82-B. In addition, USER B earns some credits when USER A votes up USER C's answer, as a reward for USER B's positive contribution in directing the question to USER C, as indicated by reference number 82-A. With some embodiments, in a situation where several users have solicited the same user for an answer to a particular question, if an answer provided by the solicited user is voted up, all of the users who solicited the user for the answer will divide a certain number of credits paid out as a reward for soliciting an answer that has been voted up. The particular number of credits could be allocated equally, or in proportion to each user's contribution (e.g., the amount each user paid to solicit an answer, or some other factor). In addition to receiving credits, the names of the users who solicited an answer to a question may be displayed on a question page next to, near, or in association with the answer provided as a result of the solicitation, assuming that the user did not solicit the answer anonymously. This allows a user to gain some public recognition for having positively contributed to the virtual community or forum by soliciting a user for an answer to a particular question. In some instances, a user may solicit an answer anonymously, or specifically request that he or she not receive any public recognition for a particular solicitation.

FIG. 4 is a user interface diagram illustrating an example of a user interface or web-page 100 of a question-and-answer service and showing how a user can select another user to whom a question is to be directed, according to an embodiment of the invention. As illustrated in FIG. 4, after a user has posted a question, or, when a user is viewing a question that has been posted by another user, one or more names of users may be suggested to the viewing user as persons who may be well-suited to provide an answer to the question. For example, in the portion of user interface with reference number 102, three names of users are presented, along with their respective Ask to Answer prices. To solicit John Smith for an answer to the question presented in this example web page will cost the viewing user fifty credits.

With some embodiments, the question-and-service service may analyze a variety of factors when recommending or suggesting to a particular user the names of other users who may be well-suited to answer a particular question, or highly likely to provide an answer, if asked to provide an answer. For instance, such factors may include any one or more of the following, in various combinations: the relationship that exists between the users as defined in a social graph maintained by the service or an external social network service, the number of questions on a particular topic that a user has previously answered, the net number of positive votes that a user's answers have received for a certain topic, a high correlation between the topics assigned to a question and the topics being followed by a user, the designation or recognition of a user as a knowledge expert on a given topic, the recency of a user's activity or interaction with the service, a user's responsiveness to past requests in general, a user's responsiveness to past requests relating to particular topics, and the frequency with which user's specifically request a user to answer questions. The algorithm for identifying and presenting the suggested users may prevent a user whose ask to answer price exceeds the credit balance of the viewing user from being presented in the list of suggested users. With some embodiments, the list of suggested users may be sorted or arranged so that the users who have received the most requests, or the users who have been the most responsive to requests, are presented most prominently in the list (e.g., at or near the top of the list). With some embodiments, when displaying the list of suggested users who might be solicited for an answer to a question, a topic-specific biographical statement pertaining to each suggested user may be presented along with the suggested user's name, to provide the viewing user with some additional information for use in assessing whether or not to direct a question to the user.

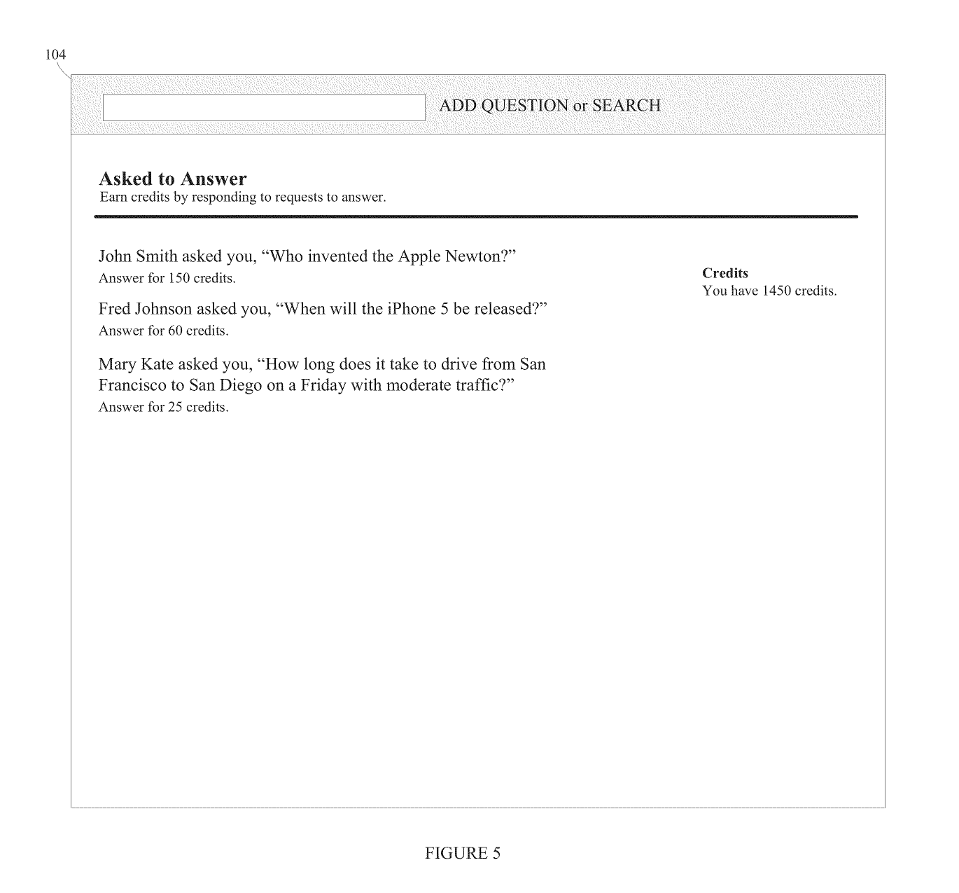

FIG. 5 is a user interface diagram showing an example of a user interface or web-page of a question-and-answer service and showing the questions that a particular user has been asked to answer, according to an embodiment of the invention. As illustrated in FIG. 5, the question-and-answer service provides a user with a user interface displaying all of the questions that have been directed to the user with a solicitation for an answer. For instance, in the example of FIG. 5, the viewing user has been asked to provide answers to three different questions. The number of credits that the viewing user can earn by answering each respective question is presented along with the questions. In some instances, for example, when multiple users have solicited a user for an answer to a question, the number of credits that can be earned for answering the question will be the sum of the Ask to Answer prices the system has presented to each soliciting user. Additionally, although not shown in FIG. 5, with some embodiments, a user may specify some additional amount of credits above a user's Ask to Answer price that is to be paid, for instance, as a bonus or tip, when soliciting another user for an answer to a question.

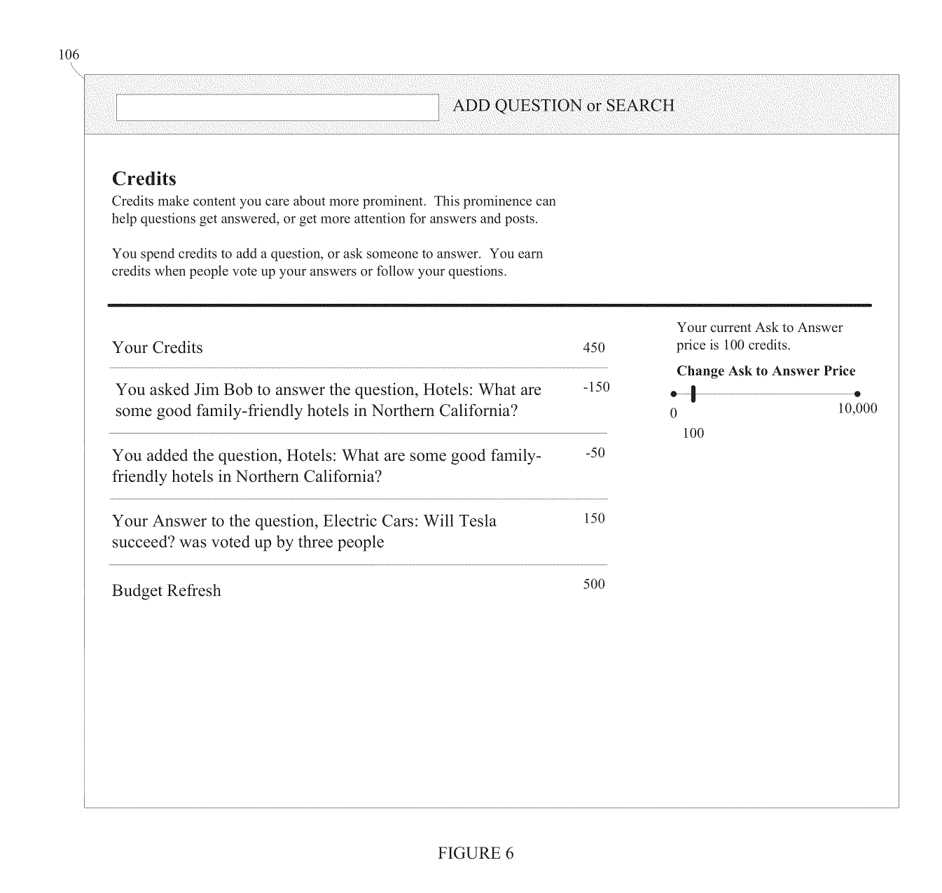

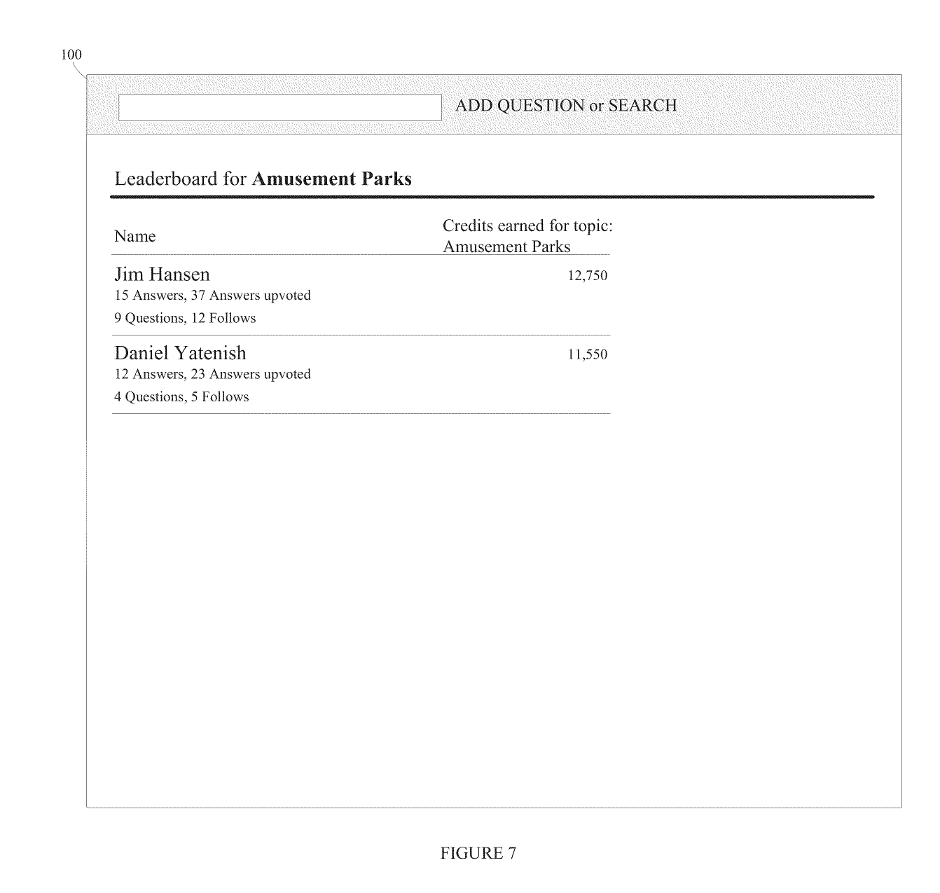

FIG. 6 is a user interface diagram illustrating an example of a user interface or web-page of a question-and-answer service and showing a list of activities for which credits have been earned and paid out, consistent with some embodiments of the invention. In the example of FIG. 7, the viewing user has a current balance of four-hundred fifty credits. The user's balance of four-hundred fifty credits is the result of having been allocated an initial five-hundred credits, earning one-hundred fifty credits for users voting up an answer to a question, paying fifty credits to post a question, and then paying one-hundred fifty credits to solicit an answer to the question. In addition to showing the various actions for which the user has paid and/or earned credits, the portion of the user interface with reference number 108 enables the user to change his or her Ask to Answer price.

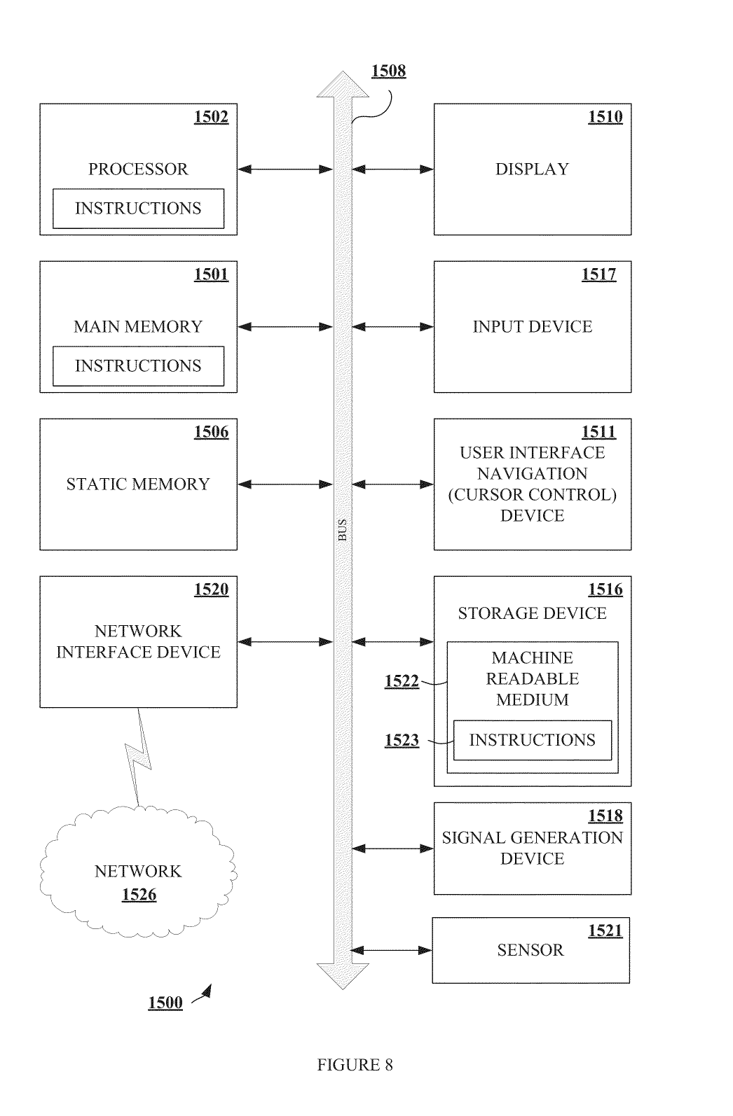

With some embodiments, the number of credits that each user has may not be displayed publically. However, with some embodiments, in order to encourage users to take certain desirable actions, the number of credits that each user has may be displayed as a way to recognize certain users for their positive contributions to the application or service. One way this may be achieved is by displaying a leaderboard as shown in the example user interface or web page of FIG. 8. In this example, the leaderboard is showing the top credit earners for a particular topic or category (e.g., Amusement Parks). However, in other embodiments, an overall (e.g., non-topic specific) leaderboard might also be presented. For a topic-specific leaderboard, such as that shown in FIG. 8, the users listed on the leaderboard are those users who have earned credits by taking certain actions with respect to certain topics. For instance, in FIG. 8, the users listed on the leaderboard have earned credits by asking and answering questions related to the topic, Amusement Parks. Only the activities relating to the particular topic (e.g., Amusement Parks) will count toward the total credits for purposes of being listed on the leaderboard. Therefore, the number of credits shown for each user may be only a portion of the total credits that the user has.

Skilled artisans will recognize that the methods and user interfaces presented herein are presented as specific examples of how the inventive concepts may be implemented. However, methods and user interfaces that differ from the specific examples presented herein may be consistent with the general scope and spirit of the inventive concepts. Particularly, the order in which certain method operations occur may vary from the examples presented herein without departing from the scope and spirit of the inventive concepts. Similarly, a wide variety of user interface elements different from those presented herein may be used to implement the inventive concepts described herein.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules or logical components referred to herein may, in some example embodiments, comprise processor-implemented modules or logic.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

FIG. 8 is a block diagram of a machine in the form of a computer within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environments, or as a peer machine in peer-to-peer (or distributed) network environments. The machine may be a personal computer (PC), a tablet PC, a set-top box (STB), a Personal Digital Assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1500 includes a processor 1502 (e.g., a central processing unit (CPU), a graphics processing unit (GPU) or both), a main memory 1501 and a static memory 1506, which communicate with each other via a bus 1508. The computer system 1500 may further include a display unit 1510, an alphanumeric input device 1517 (e.g., a keyboard), and a user interface (UI) navigation device 1511 (e.g., a mouse). In one embodiment, the display, input device and cursor control device are a touch screen display. The computer system 1500 may additionally include a storage device (e.g., drive unit 1516), a signal generation device 1518 (e.g., a speaker), a network interface device 1520, and one or more sensors 1521, such as a global positioning system sensor, compass, accelerometer, or other sensor.

The drive unit 1516 includes a machine-readable medium 1522 on which is stored one or more sets of instructions and data structures (e.g., software 1523) embodying or utilized by any one or more of the methodologies or functions described herein. The software 1523 may also reside, completely or at least partially, within the main memory 1501 and/or within the processor 1502 during execution thereof by the computer system 1500, the main memory 1501 and the processor 1502 also constituting machine-readable media.

While the machine-readable medium 1522 is illustrated in an example embodiment to be a single medium, the term “machine-readable medium” may include a single medium or multiple media (e.g., a centralized or distributed database, and/or associated caches and servers) that store the one or more instructions. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

The software 1523 may further be transmitted or received over a communications network 1526 using a transmission medium via the network interface device 1520 utilizing any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., Wi-Fi® and WiMax® networks). The term “transmission medium” shall be taken to include any intangible medium that is capable of storing, encoding or carrying instructions for execution by the machine, and includes digital or analog communications signals or other intangible medium to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

What is claimed is:

1. A method comprising:
establishing an initial price, payable in credits, for initiating interaction with a particular user of a web-based application;
with a processor-implemented price-setting module, regulating the price for initiating interaction with the particular user by adjusting the initial price to a new price based on one or more observed factors from which the particular user's willingness to interact via the web-based application can be inferred, and/or one or more observed factors from which the collective demand for the particular user's attention from other user of the web-based application can be inferred; and
causing the new price to be displayed when presenting a user interface via which a user of the web-based application can initiate interaction with the particular user.

2. The method of claim 1, wherein one observed factor from which the particular user's willingness to interact via the web-based application can be inferred is the historical rate at which the particular user responds to user-initiated interactions directed to the particular user from other users of the web-based application over a period of time.

3. The method of claim 1, wherein one observed factor from which the collective demand for the particular user's attention from other users of the web-based application can be inferred is the historical rate of user-initiated interactions directed to the particular user over a period of time.

4. The method of claim 1, wherein regulating the price for initiating interaction with the particular user by adjusting the initial price to a new price based on one or more observed factors from which the particular user's willingness to interact via the web-based application can be inferred, and/or one or more observed factors from which the collective demand for the particular user's attention from other users of the web-based application can be inferred includes increasing the initial price to the new price when the historical rate of user-initiated interactions directed to the particular user over the period of time exceeds some target rate that has been personalized for the particular user based on the historical rate at which the particular user responds to user-initiated interactions directed to the particular user from other users of the web-based application.

5. The method of claim 1, further comprising:
enabling the particular user to override the price setting module by manually setting the new price for initiating interaction with the particular user.

6. The method of claim 5, further comprising:
upon determining that the particular user has manually set the new price for initiating interaction with the particular user, adjusting the target rate for the particular user to correspond with the change in the price.

7. The method of claim 1, wherein regulating the price for initiating interaction with the particular user by adjusting the initial price to a new price based on one or more observed factors from which the particular user's willingness to interact via the web-based application can be inferred, and/or one or more observed factors from which the collective demand for the particular user's attention from other users of the web-based application can be inferred includes decreasing the initial price to the new price when the historical rate of user-initiated interactions directed to the particular user over the period of time is less than some target rate that has been personalized for the particular user based on the historical rate at which the particular user responds to user-initiated interactions directed to the particular user from other users of the web-based application.

8. The method of claim 1, wherein the web-based application facilitates a question-and-answer service via which a user of the web-based application can solicit another user for an answer to a question, and said regulating the price for initiating interaction with the particular user includes increasing the price for soliciting the particular user for an answer to a question that has been posted to, and is publically viewable via, the question-and-answer service when the historical rate of user-initiated interactions directed to the particular user over the period of time exceeds some target rate that has been personalized for the particular user based on the historical rate at which the particular user responds to user-initiated interactions directed to the particular user from other users of the web-based application.

9. The method of claim 1, wherein the web-based application facilitates a messaging service via which users can communicate messages to one another, and said regulating the price for initiating interaction with the particular user includes increasing the price for initiating interaction with the particular user by directing a message to the particular user when a historical rate of messages received by the particular user exceeds some target rate over a particular period of time.

10. The method of claim 1, further comprising:
determining that a user has initiated interaction with the particular user via the user interface; and
debiting from an account of the user a number of credits equivalent to the new price for initiating interaction with the particular user of the web-based application.

11. A computer-readable storage medium storing instructions thereon, which, when executed by a processor of a server computer, cause the server computer to perform a method comprising:
establishing an initial price, payable in credits, for initiating interaction with a particular user of a web-based application;
with a processor-implemented price-setting module, regulating the price for initiating interaction with the particular user by adjusting the initial price to a new price based on one or more observed factors from which the particular user's willingness to interact via the web-based application can be inferred, and/or one or more observed factors from which the collective demand for the particular user's attention from other user of the web-based application can be inferred; and
causing the new price to be displayed when presenting a user interface via which a user of the web-based application can initiate interaction with the particular user.

12. A method comprising:
establishing for a particular user an ask to answer price, payable in credits, that other users of a question-and-answer service are required to pay to solicit the particular user for an answer to a question that has been for posted to the service;
with a processor-implemented price-setting module, periodically adjusting the particular user's ask to answer price based on data observed over a period of time and from which a measure of demand for the particular user's attention can be inferred; and
causing the ask to answer price to be displayed when presenting a user interface via which a user of the web-based application can solicit the particular user for an answer to a question.

13. The method of claim 12, wherein the data observed over a period of time and from which a measure of demand for the particular user's attention can be inferred is the number of answers to questions that other users have solicited from the particular user over the period of time.

14. The method of claim 13, wherein periodically adjusting the particular user's ask to answer price based on data observed over a period of time and from which a measure of demand for the particular user's attention can be inferred includes increasing the particular user's ask to answer price when the number of answers to questions that other users have solicited from the particular user over the period of time exceeds some target number that has been adjusted for the particular user based in part on data observed over the period of time and from which a measure of the particular user's willingness to answer questions can be inferred.

15. The method of claim 14, wherein the data observed over the period of time and from which a measure of the particular user's willingness to answer questions can be inferred is the number of answers that the particular user has provided per the number of answers to questions that other users have solicited from the particular user over the period of time.

16. The method of claim 12, further comprising:
paying out to the particular user a number of credits that is a portion of the particular user's ask to answer price when another user solicits the particular user for an answer to a question.

17. The method of claim 12, further comprising:
paying out to the particular user a number of credits equivalent to the particular user's ask to answer price when the particular user posts an answer to a question in response to another user soliciting the particular user for the answer to the question.

18. The method of claim 17, further comprising:
paying out a number of credits to the particular user when another user of the question-and-answer service votes up the answer that the particular user has posted to the question.

19. The method of claim 17, further comprising:
paying out a number of credits to the user who solicited the particular user for an answer to the question when another user votes up the answer to the question posted by the particular user.

20. The method of claim 12, further comprising:
debiting a number of credits from a credit account of a user when the user posts a question via the question-and-answer service.

21. The method of claim 20, further comprising:
paying out a number of credits to the user who has posted the question via the question-and-answer service when another user follows the question via the question-and-service.

22. The method of claim 12, further comprising:
presenting with the user interface names of suggested users to whom another user might solicit an answer to a question and each suggested user's respective ask to answer price, the suggested users selected with an algorithm that is based on any combination of factors including: the number of questions on a particular topic that a suggested user has previously answered, the net number of positive votes that a suggested user's answers have received from other users for a certain topic, a high correlation between topics assigned to a question and topics being followed by a suggested user, a designation or recognition of a suggested user as a knowledge expert on a given topic, the recency with which a suggested user has interacted with the question-and-answer service, and/or a measure of how responsive the suggested user has been with respect to solicitations for answers to questions.
